(19) United States
(12) Patent Application Publication
(10) Pub. No.: US 2015/0298003 A1
(43) Pub. Date: Oct. 22, 2015

(54) CHECKPOINT SAVE OPTION FOR A VIDEO GAME

(71) Applicant: Xaviant, LLC, Cumming, GA (US)

(72) Inventors: Michael Parker McMain, Cumming, GA (US); Craig John Lipinski, Cumming, GA (US)

(73) Assignee: Xaviant, LLC, Cumming, GA (US)

(21) Appl. No.: 14/257,445

(22) Filed: Apr. 21, 2014

(51) Int. Cl. A63F 13/49; A63F 13/533

(52) U.S. Cl. CPC A63F 13/49; A63F 13/533

(57) ABSTRACT

In an example, a game player may be provided with an option to postpone an exit from a video game until a next checkpoint. In particular, an exit command may be received from the game player during a video game session. Upon receiving the exit command, a first option menu is displayed to the game player. The displayed first option menu may include a delay option to postpone the exit from the video game until the next checkpoint. When the next checkpoint is reached, a progress of the game player in the video game is saved and a second option menu may be displayed to the game player. The second option menu may include an exit option to quit the video game immediately.

### BACKGROUND

In a video game, digitally stored information about the progress of a game player may be saved. The game player may save the video game to prevent a loss of progress in the video game when a game session is ended or interrupted. Accordingly, the saved video game can be reloaded later, so the player can resume playing at the point the video game was saved. Depending on the video game, the game player may have the ability to save the game at an arbitrary point, after a specific task has been completed, or at designated areas within the video game known as checkpoints.

In modern video games, such as role-playing video games, the progress of the game player may only be saved at predetermined checkpoints. Checkpoints are locations in the video game where the progress or status of the game player is saved and where a virtual game character of the game player respawns in the status saved by the checkpoint. A respawn is often due to the death of the virtual game character, but it can also be caused by the failure to meet an objective required to advance in the video game. Checkpoints are employed either because the video game is too complex to allow saving at any given point or to make the video game more engaging by forcing the game player to rely on skills without the ability to retry a challenge from the same point indefinitely.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a machine to provide a game player with an option to postpone an exit from a video game until a next checkpoint, according to an example of the present disclosure;

FIG. 2 shows a flow diagram of the method to provide a game player with an option to postpone an exit from a video game until a next checkpoint, according to an example of the present disclosure;

FIG. 3 shows a flow diagram of the method to display a first option menu, according to an example of the present disclosure;

FIGS. 4A and 4B show a first option menu, according to examples of the present disclosure;

FIG. 5 shows a map to display progress data and estimate data, according to an example of the present disclosure;

FIG. 6 shows a flow diagram of a method a flow diagram of a method to display a second option menu, according to an example of the present disclosure; and

FIG. 7 shows a second option menu, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Disclosed herein are examples of a method to provide a game player with an option to postpone an exit from a video game until a next checkpoint. Also disclosed herein is a system for implementing the disclosed methods and a non-transitory computer readable medium on which is stored machine readable instructions that implement the disclosed methods.

According to a disclosed example, a game player may be provided with an option to postpone an exit from a video game until a next checkpoint. In particular, an exit command may be received from the game player during a video game session. Upon receiving the exit command, a first option menu is displayed to the game player. The displayed first option menu may include a delay option to postpone the exit from the video game until the next checkpoint. When the next checkpoint is reached, a progress of the game player in the video game is saved and a second option menu may be displayed to the game player. The second option menu may include an exit option to quit the video game immediately.

According to an example, the first option menu may include progress data for the game player that is accumulated since a previous checkpoint. The first option menu may further include an estimated time for the game player to reach the next checkpoint. According to another example, the second option menu may include progress data for the game player that is accumulated since a previous checkpoint. The second option menu may further include an estimated time for the game player to reach another checkpoint.

The examples of the present disclosure communicate to the game player an amount of progress that is lost if the game player chooses to exit the video game. By providing the game player with this progress data, the game player is afforded the opportunity to consider this progress data prior to exiting the video game. For example, in response to receiving an exit command, the game player is provided an option menu that includes the progress data of the game player at that particular point in time. If the progress data, for instance, indicates that the game player is near reaching the next checkpoint, the game player may decide to continue forward in the video game and postpone exiting until the next checkpoint to avoid losing all progress since the last checkpoint.

Additionally, the examples of the present disclosure communicate to the game player the exact time that a checkpoint save has occurred. For example, the second menu option is conspicuously displayed to the game player when a checkpoint has been reached and the save has occurred. Accordingly, the game player is provided accurate feedback as to when a checkpoint save has occurred so that the game player may securely and safely quit the video game without losing any progress.

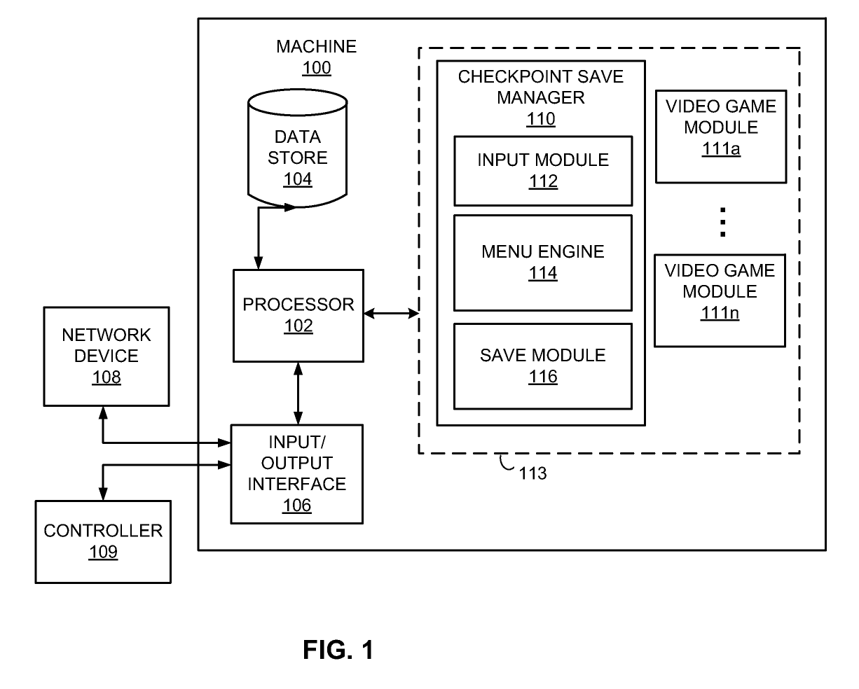

With reference to FIG. 1, there is shown a block diagram of a machine 100 to provide a game player with an option to postpone an exit from a video game until a next checkpoint, according to an example of the present disclosure. It should be understood that the machine 100 may include additional components and that one or more of the components described herein may be removed and/or modified without departing from a scope of the machine 100.

The machine 100 is depicted as including a processor 102, a data store 104, an input/output interface 106, a checkpoint save manager 110, and a controller 109. The machine 100 may be a computer. For example, the computer may be a personal computer, game console, server, mobile handset, etc., but other types of computers may be used. Also, the components of the machine 100 are shown on a single computer as an example and in other examples the components may exist on multiple computers. The machine 100 may store progress data in a video game for a game player in the data store 104 and/or may manage the storage of data stored in a separate machine, for instance, through a network device 108, which may comprise, for instance, a router, a switch, a hub, etc. The data store 104 includes a storage device, such as hard disk, memory, etc.

The checkpoint save manager 110 is depicted as including an image input module 112, a menu engine 114, and a save module 116. The processor 102, which may comprise a microprocessor, a micro-controller, an application specific integrated circuit (ASIC), or the like, is to perform various processing functions in the machine 100. The processing functions may include the functions of the image input module 112, the estimator engine 114, and the data output module 116 of the checkpoint save manager 110 as discussed in greater detail herein below.

In one example, the checkpoint save manager 110 comprises machine readable instructions stored on a non-transitory computer readable medium 113 and executed by the processor 102. Examples of the non-transitory computer readable medium include dynamic random access memory (DRAM), electrically erasable programmable read-only memory (EEPROM), magnetoresistive random access memory (MRAM), memristor, flash memory, hard drive, and the like. The computer readable medium 113 may be included in the data store 104 or may be a separate storage device. In another example, the checkpoint save manager 110 comprises a hardware device, such as a circuit or multiple circuits arranged on a board. In this example, the input module 112, the menu engine 114, and the save module 116 comprise circuit components or individual circuits, such as an embedded system or Application-Specific Integrated Circuit (ASIC) or Field-Programmable Gate Arrays (FPGAs).

The input/output interface 106 comprises a hardware and/or a software interface. The input/output interface 106 may be a network interface connected to a network, such as the Internet, an intranet, etc., over which the checkpoint save manager 110 may receive and communicate information. The processor 102 may store information received through the input/output interface 106 in the data store 104 and may use the information in implementing the input module 112, the menu engine 114, and the save module 116. The data store 104 may include volatile and/or non-volatile data storage.

According to another example, a game player may transmit a plurality of commands from the controller 109 to the processor 102 via the input/output interface 106. The controller 109 may be a device to provide user input to the machine 100. The controller 109 may be used with video games or entertainment systems to provide input to the video game, typically to control an object or character in the video game. The controller 109 may be connected to the machine 100 by a cord or wirelessly. The controller 109 may include, but is not limited to, a gamepad, a paddle, a joystick, a trackball, a throttle quadrant, a steering wheel, a yoke, a pedal, a keyboard and mouse, a touch screen, a motion sensing device, a light gun, a microphone, a rhythm game controller, and dance pad. The processor 102 may implement the commands received through the input/output interface 106 during gameplay of the video game. For instance, the processor 102 may implement the received commands in the input module 112, the menu engine 114, and the save module 116 of the checkpoint save manager 110. According to an example, the checkpoint save manager 110 may be a module, whereby a module may include machine readable instructions to perform certain functions, of multiple modules that are executed to play the video game. For example, video game modules 111a-n are shown to represent other modules performing other functions for a video game. Together, the checkpoint save manager 110 and the modules 111a-n comprise the software for the video game.

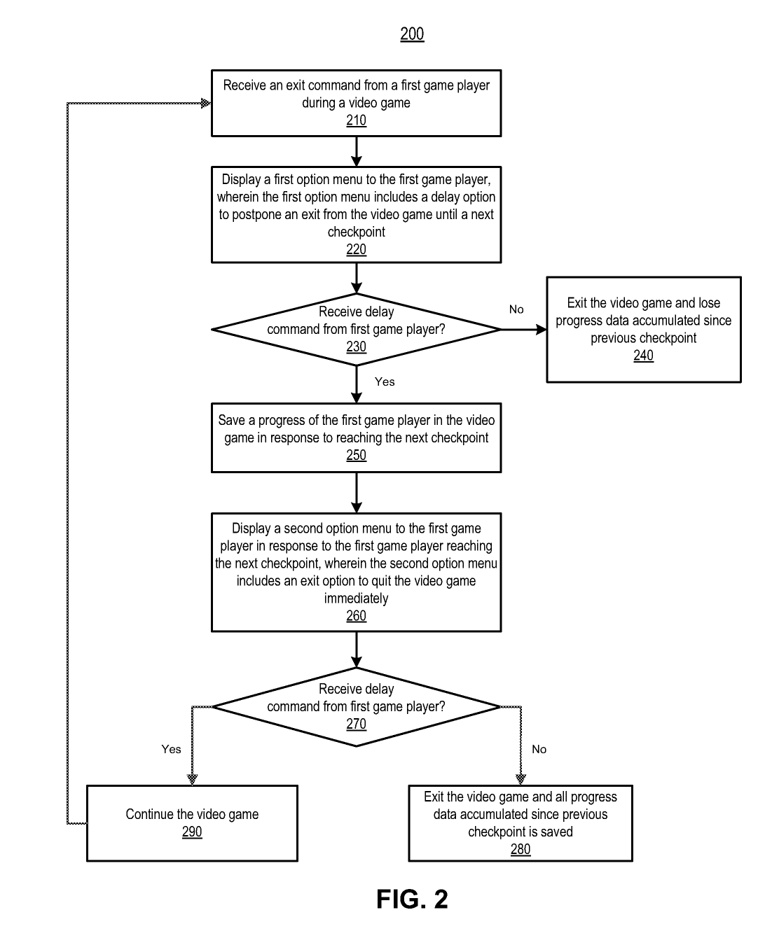

The input module 112, the menu engine 114, and the save module 116 of the checkpoint save manager 110 are operable to provide a game player with an option to postpone an exit from a video game until a next checkpoint as described herein. The input module 112, for instance, may receive an exit command from a game player during a video game. The menu engine 114, for instance, may display a first option menu to the first game player responsive to the exit command. According to an example, the first option menu may include a delay option to postpone an exit from the video game until a next checkpoint. The menu engine 114 may, for instance, further display a second option menu to the game player responsive to the first game player reaching the next checkpoint. According to an example, the second option menu may include an exit option to quit the video game immediately. The save module 116, for instance, may save a progress of the first game player in the video game responsive to reaching the next checkpoint. The functions of the input module 112, the menu engine 114, and the save module 116 are discussed in greater detail with respect to methods 200, 300, and 600 in FIGS. 2, 3, and 6.

FIGS. 2, 3, and 6 respectively depict flow diagrams of methods 200, 300 and 600 to provide a game player with an option to postpone an exit from a video game until a next checkpoint, according to examples of the present disclosure. It should be apparent to those of ordinary skill in the art that the methods 200, 300, and 600 represent generalized illustrations and that other operations may be added or existing operations may be removed, modified or rearranged without departing from the scopes of the methods 200, 300, and 600. Methods 300 and 600 are related to the method 200 in that methods 300 and 600 include operations in addition to those included in the method 200. Thus, methods 300 and 600 may be construed as including all of the features discussed with respect to the method 200.

With reference to FIG. 2, there is shown a flow diagram of the method 200 to provide a game player with an option to postpone an exit from a video game until a next checkpoint, according to an example of the present disclosure. The method 200 may be implemented, for instance, by the processor 102 of machine 100 as depicted in FIG. 1.

In FIG. 2, the input module 112, for instance, may receive an exit command from a first game player during a video game, as shown in block 210. The first game player may transmit the exit command from the controller 109 to the input module 112 via the input/output interface 106. For example, the first game player may press a designated button or a series of buttons on the controller 109 to initiate an exit from the video game at any point in time during gameplay.

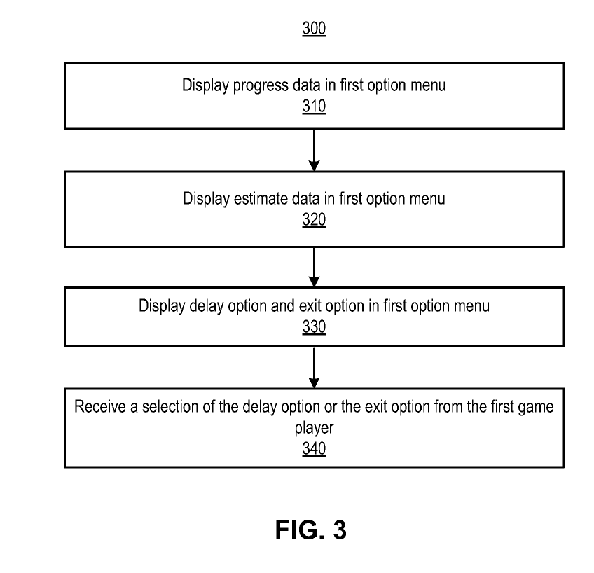

As shown in block 220, the menu engine 114, for instance, may display a first option menu to the first game player responsive to receiving the exit command from the first game player. According to an example, the first option menu may include a delay option to postpone an exit from the video game until a next checkpoint. The first option menu may also include an exit option that allows the game player to exit the video game immediately and, consequently, lose all game progress since the previous checkpoint. To aid the first game player in deciding whether to postpone the exit of the video game or to exit the video game immediately, the first option menu may display progress data that has been accumulated by the first game player since a previous checkpoint and estimate data for the first game player to reach the next checkpoint. The progress data and estimate data of the first option menu of the present disclosure is discussed in further detail below with respect to method 300 in FIG. 3.

In block 230, the input module 112 may receive an input command from the controller 109 of the first game player responsive to the options presented in the first option menu. If the input module 112 receives an exit command from the first game player to quit the video game, the video game is exited and all progress data accumulated since the previous checkpoint is lost as shown in block 240.

On the other hand, if the input module 112 receives a delay command from the controller 109 of the first game player to postpone an exit from the video game in block 230, the method 200 continues to block 250. Referring to block 250, the save module 116, for instance, may save a progress of the first game player in the video game in the data store 104 in response to reaching the next checkpoint. Concurrent to reaching the next checkpoint, a second option menu may be displayed to the first game player, as shown in block 260.

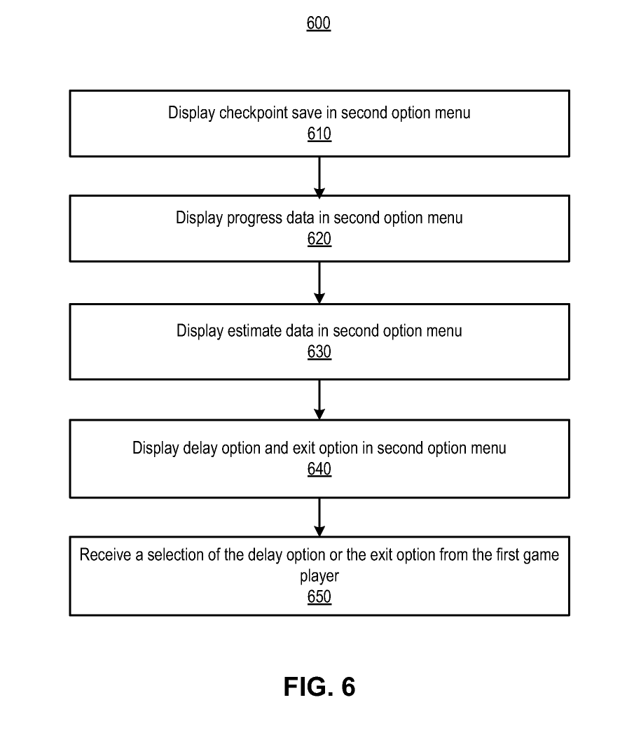

The second option menu may include an exit option to quit the video game immediately. In this case, no progress in the video game is lost by the first game player since the game is saved upon reaching the next checkpoint. The second option menu may also include a delay option to postpone an exit from the video game until another checkpoint. To aid the first game player in deciding whether to postpone the exit of the video game or to exit the video game immediately, the second option menu may display progress data that has been accumulated by the first game player since a previous checkpoint and estimate data for the first game player to reach another checkpoint. According to an example, the estimate data to reach another checkpoint may include one or more subsequent checkpoints in the videogame. The progress data and estimate data of the second option menu of the present disclosure is discussed in further detail below with respect to method 600 in FIG. 6.

In block 270, the input module 112 may receive an input command from the controller 109 of the first game player responsive to the options presented in the second option menu. If the input module 112 receives an exit command from the controller 109 of the first game player to quit the video game, the video game is exited immediately and all progress data accumulated since the previous checkpoint is saved as shown in block 280. However, if the input module 112 receives a delay command from the controller 109 of the first game player to postpone an exit from the video game in block 270, the video game is continued and all progress data accumulated since the previous checkpoint is saved as shown in block 290. According to an example, the method 200 then awaits a next exit command from the first game player as shown in block 210.

With reference to FIG. 3, there is shown a flow diagram of the method 300 to display the first option menu according to an example of the present disclosure. The method 300 may be implemented, for instance, by the processor 102 of machine 100 as depicted in FIG. 1.

In response to receiving the exit command from the first game player during the video game, as shown in block 210 of FIG. 2 above, the menu engine 114, for instance, may display the first option menu. The first option menu may display at least one of progress data (block 310), estimate data (block 320), and delay and exit options (block 330) to the first game player as further discussed below with respect to FIG. 3.

According to an example, the progress data that has been accumulated by the first game player since a previous checkpoint may be displayed in the first option menu, as shown in block 310. For instance, the progress data that is displayed to the first game player may include, but is not limited to, one or more of a plurality of elapsed time between checkpoints, enemies defeated, distance traveled, skills acquired, items acquired, and health status.

According to another example, the estimate data, which includes an estimated time for the first game player to reach the next checkpoint, may be displayed in the first option menu, as shown in block 320. The estimate data, for instance, may be based on an average amount of time required by other game players of the video game to reach the next checkpoint. In order to obtain an accurate estimate of the average amount of time required by other game players to reach the next checkpoint, the method 300 may track other game players that have the same skill level as the first game player in the estimate calculation. Additionally, the estimate data may be based on tracking other game players that are using virtual game characters with similar accumulated ability sets to a virtual game character of the first game player. The estimate data that is displayed to the first game player may include, but is not limited to, at least one of a number of undefeated enemies remaining and distance remaining.

According to another example, a delay option and an exit option may be displayed in the first option menu, as shown in block 330. The delay option, for instance, may postpone an exit from the video game until a next checkpoint. The exit option may allow the game player to exit the video game immediately and, consequently, lose all game progress since the previous checkpoint. As shown in blocks 310 and 320 above, the progress data and the estimate data that is displayed in the first option menu may provide information to the first game player to help the first game player decide whether to postpone the exit of the video game or to exit the video game immediately.

At block 340, the menu engine 114, for instance, may receive a selection of the delay option or the exit option from the first game player. According to an example, after considering the progress data and/or the estimate data displayed in the first option menu, the first game player may input a delay command or an exit command to the menu engine 114 from the controller 109.

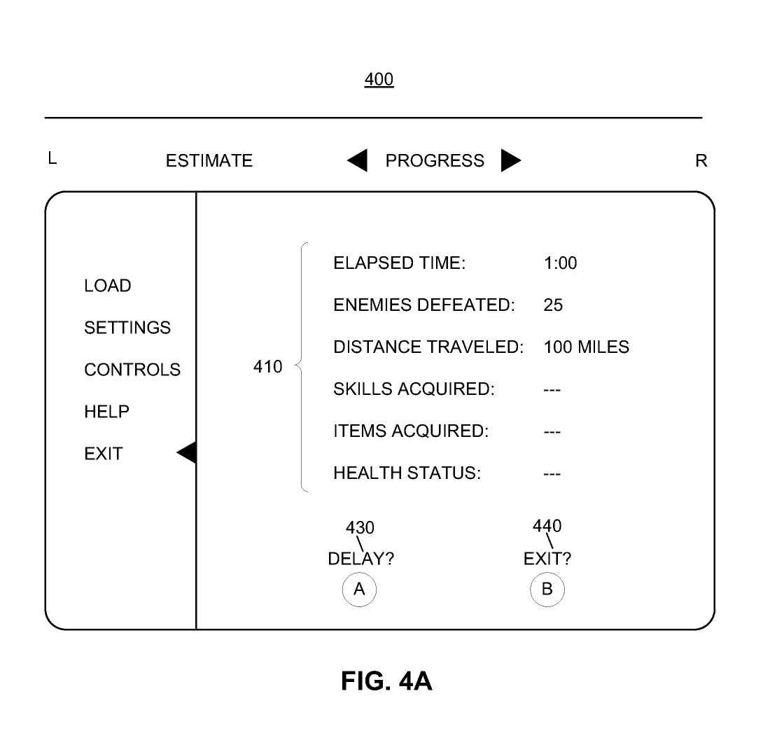

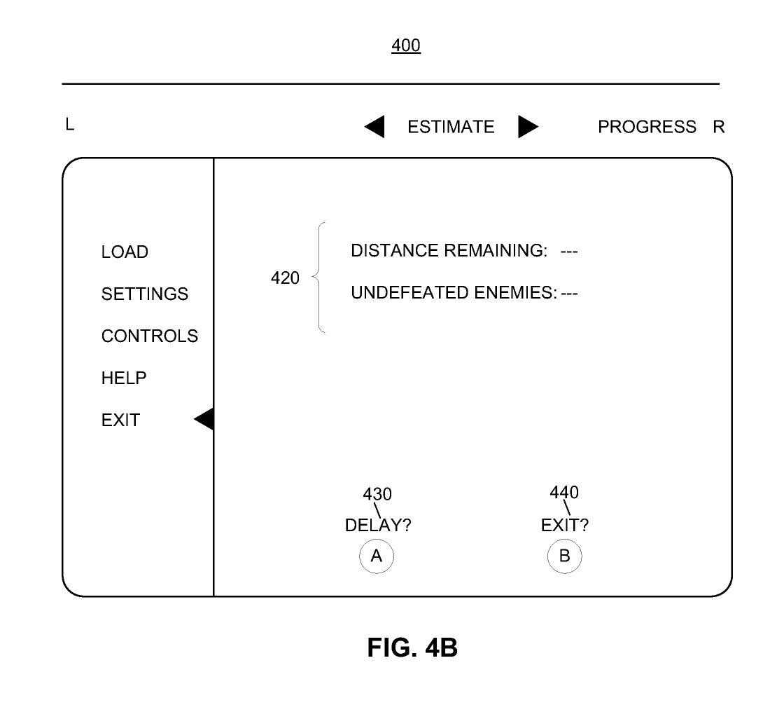

FIGS. 4A and 4B depict examples of a first option menu 400 according to the present disclosure. FIG. 4A illustrates an example of the first option menu 400 displaying progress data 410 that has been accumulated by the first game player since a previous checkpoint. FIG. 4B illustrates an example of the first option menu 400 displaying estimate data 420 for the first game player to reach the next checkpoint. The first game player may scroll between the progress data 410 and the estimate data 420 by pressing designated buttons on the controller 109. For instance, the game player may press a left or right trigger button on a gamepad to scroll between the progress data 410 and the estimate data 420. As shown in FIGS. 4A and 4B, the first option menu may display a delay option 430 and an exit option 440 to the first game player. Accordingly, the first game player may select one of the delay option 430 or the exit option 440 by pressing designated buttons on the controller 109. For instance, the game player may press the ‘A’ button to select the delay option or may press the ‘B’ button to select the exit option.

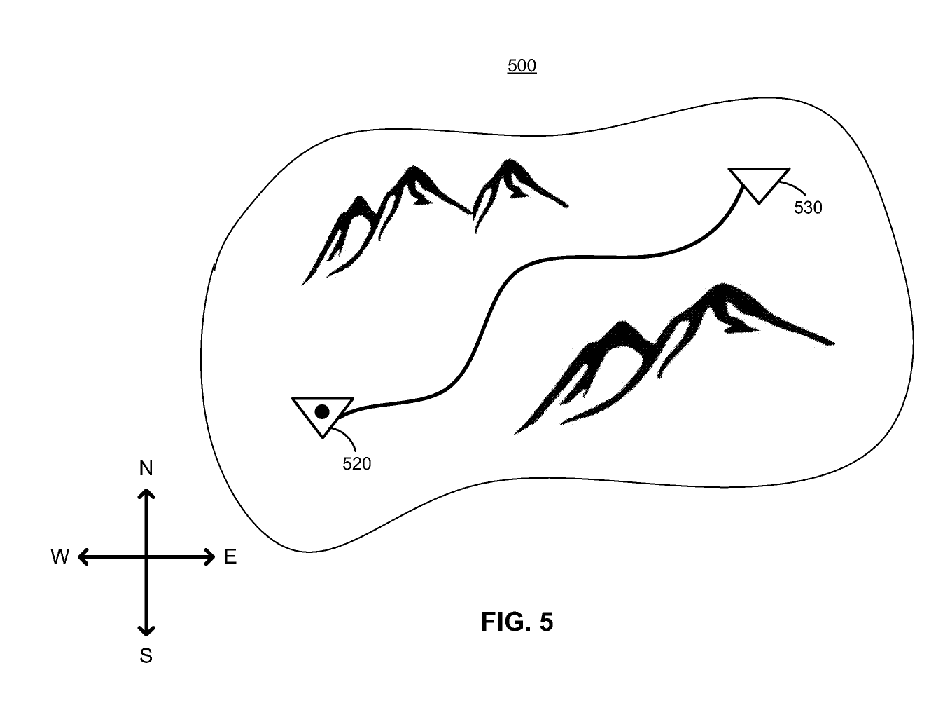

FIG. 5 depicts an example of a map 500 for the video game according to the present disclosure. The map 500, for instance, may provide the first game player with detailed information regarding the progress data 410 and the estimate data 420. For example, the map 500 may show a current position 510 of the game player on the map 500. Additionally, the map 500 may show the distance traveled from the previous checkpoint 520 and the distance remaining to the next checkpoint 530, according to an example.

With reference to FIG. 6, there is shown a flow diagram of the method 600 to display the second option menu according to an example of the present disclosure. The method 600 may be implemented, for instance, by the processor 102 of machine 100 as depicted in FIG. 1.

As shown above in FIG. 2, the progress of the first game player is saved in response to reaching the next checkpoint at block 250 and the second option menu may be concurrently displayed to the first game player as shown in block 260. According to an example, the second option menu may display at least one of a checkpoint save (block 610), progress data (block 620), estimate data (block 630), and delay and exit options (block 640) to the first game player as further discussed below with respect to FIG. 6.

At block 610, the menu engine, for instance, may display a checkpoint save in the second option menu. The display of the checkpoint save may include a conspicuous alert or notification that informs the first game player that an autosave has occurred, according to an example. Accordingly, the first game player may be provided with accurate feedback as to when a checkpoint save has occurred so that the game player may securely and safely quit the video game without losing any progress.

At block 620, the progress data that has been accumulated by the first game player since the previous checkpoint may be displayed in the second option menu according to an example. For instance, the progress data that is displayed to the first game player may include, but is not limited to, one or more of a plurality of elapsed time between checkpoints, enemies defeated, distance traveled, skills acquired, items acquired, and health status.

At block 630, the estimate data, which includes an estimated time for the first game player to reach another checkpoint, may be displayed in the second option menu. The estimate data, for instance, may be based on an average amount of time required by other game players of the video game to reach another checkpoint. In order to obtain an accurate estimate of the average amount of time required by other game players to reach another checkpoint, the method 600 may track other game players that have the same skill level as the first game player in the estimate calculation. Additionally, the estimate data may be based on tracking other game players that are using virtual game characters with similar accumulated ability sets to a virtual game character of the first game player. The estimate data that is displayed to the first game player may include, but is not limited to, at least one of a number of undefeated enemies remaining and distance remaining. According to an example, the estimate data to reach another checkpoint may include one or more subsequent checkpoints in the videogame.

At block 640, a delay option and an exit option may be displayed in the second option menu. The delay option of the second option menu, for instance, may postpone an exit from the video game until another checkpoint. The exit option of the second option menu may allow the game player to exit the video game immediately without losing any progress. As shown in blocks 620 and 630 above, the progress data and the estimate data that is displayed in the second option menu may provide information to the first game player to help the first game player decide whether to postpone the exit of the video game or to exit the video game immediately.

As shown in block 650, the menu engine 114, for instance, may receive a selection of the delay option or the exit option from the first game player. According to an example, after considering the progress data and/or the estimate data displayed in the first option menu, the first game player may input a delay command or an exit command to the menu engine 114 from the controller 109.

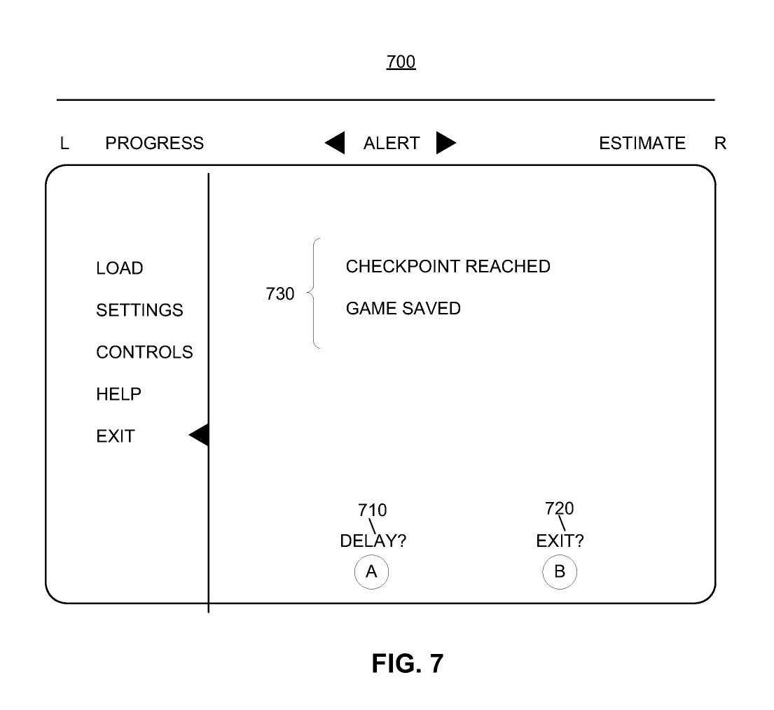

FIG. 7 depicts an example of a second option menu 700 according to the present disclosure. Similar to the first option menu 400 illustrated in FIGS. 4A and 4B, the second option menu 700 may display progress data, estimate data, a delay option 710, and an exit option 720 to the first game player. The second option menu 700, for instance, may also display a checkpoint save 730. As discussed in block 610 of FIG. 6, the checkpoint save 730 may include a conspicuous alert or notification that informs the first game player that an autosave has occurred when a checkpoint is reached.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method comprising:
receiving, by a processor, an exit command from a first game player during a video game;
displaying a first option menu to the first game player, wherein the first option menu includes a delay option to postpone an exit from the video game until a next checkpoint; and
in response to reaching the next checkpoint,
saving a progress of the first game player in the video game, and
displaying a second option menu to the first game player, wherein the second option menu includes an exit option to quit the video game immediately.

2. The method of claim 1, wherein the first option menu comprises progress data for the first game player that is accumulated since a previous checkpoint.

3. The method of claim 2, wherein the first option menu progress data comprises a plurality of elapsed time between checkpoints, enemies defeated, distance traveled, skills acquired, items acquired, and health status.

4. The method of claim 1, wherein the first option menu comprises estimate data for the first game player, wherein the estimate data includes an estimated time for the first game player to reach the next checkpoint.

5. The method of claim 4, wherein the estimate data is based on an average amount of time required by other game players of the video game to reach the next checkpoint.

6. The method of claim 5, wherein the other game players have the same skill level as the first game player.

7. The method of claim 5, wherein the other game players are using virtual game characters with similar accumulated ability sets to a virtual game character of the first game player.

8. The method of claim 4, wherein the estimate data comprises at least one of a number of undefeated enemies remaining and distance remaining.

9. The method of claim 1, wherein the second option menu comprises progress data for the first game player that is accumulated since a previous checkpoint.

10. The method of claim 9, wherein the second option menu progress data comprises plurality of elapsed time between checkpoints, enemies defeated, distance traveled, skills acquired, items acquired, and health status.

11. The method of claim 1, wherein the second option menu comprises estimate data for the first game player, wherein the estimate data includes an estimated time for the first game player to reach another checkpoint.

12. The method of claim 11, wherein the estimate data is based on an average amount of time required by other game players to reach the next checkpoint.

13. The method of claim 11, wherein the estimate data comprises at least one of a number of undefeated enemies remaining and distance remaining.

14. The system comprising:
an input module to receive an exit command from a first game player during a video game;
a menu engine to
display a first option menu to the first game player responsive to the exit command, wherein the first option menu includes a delay option to postpone an exit from the video game until a next checkpoint, and
display a second option menu to the first game player responsive to reaching the next checkpoint, wherein the second option menu includes an exit option to quit the video game immediately; and
a save module to save a progress of the first game player in the video game responsive to reaching the next checkpoint.

15. The system of claim 14, wherein the menu engine is to display the first option menu comprising progress data for the first game player that is accumulated since a previous checkpoint.

16. The system of claim 14, wherein the menu engine is to display the first option menu comprising estimate data for the first game player, wherein the estimate data includes an estimated time for the first game player to reach the next checkpoint.

17. The system of claim 14, wherein the menu engine is to display the second option menu comprising progress data for the first game player that is accumulated since a previous checkpoint.

18. The system of claim 14, wherein the menu engine is to display the second option menu comprising estimate data for the first game player, wherein the estimate data includes an estimated time for the first game player to reach another checkpoint.

19. A non-transitory computer readable medium including machine readable instructions executable by a processor to:
receive an exit command from a first game player during a video game;
postpone an exit from the video game until a next checkpoint; and
in response to reaching the next checkpoint,
save a progress of the first game player in the video game, and
exit the video game immediately.

20. The non-transitory computer readable medium of claim 19, wherein the machine readable instructions are executable by a processor to:
display a first option menu to the first game player responsive to receiving the exit command, wherein the first option menu includes a delay option, progress data for the first game player that is accumulated since a previous checkpoint, and estimate data for the first game player to reach the next checkpoint; and
display a second option menu to the first game player responsive to reaching the next checkpoint, wherein the second option menu includes an exit option, progress data for the first game player that is accumulated since a previous checkpoint, and estimate data for the first game player to reach another checkpoint.
